(19) United States
(12) Patent Application Publication
(10) Pub. No.: US 2012/0209584 A1
(43) Pub. Date: Aug. 16, 2012

(54) Advanced Metering Infrastructure Simulation

(75) Inventors: Gregory Ray Floyd, McDonough, GA (US); Eric A. Morris, Acworth, GA (US)

(73) Assignee: SOUTHERN COMPANY SERVICES, INC., Atlanta, GA (US)

(21) Appl. No.: 13/025,278

(22) Filed: Feb. 11, 2011

(51) Int. Cl. G06G 7/62

(52) U.S. Cl. 703/17; 703/13

(57) ABSTRACT

Disclosed are various embodiments for systems and methods facilitating simulation of metering devices in an advanced metering infrastructure (AMI) deployment. Meter simulators are executed in a simulation application, and a user can initiate a simulation based upon various operational scenario the user desires to simulate.

### BACKGROUND

Advanced Metering Infrastructure (AMI) deployments are increasing in prevalence because the AMI deployments can reduce labor costs as well as increase billing efficiency relative to other utility metering deployments. AMI deployments can involve a large number of AMI metering devices across a geographically disparate area. Accordingly, it may be desirable to test the robustness of computing infrastructure that manages data received from and/or sent to an AMI deployment.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a utility computing environment according to various embodiments of the present disclosure.

FIG. 2 is a drawing of the metering simulation service from the utility computing environment of FIG. 1 according to various embodiments of the present disclosure.

FIG. 3 is a drawing of an example of a user interface rendered by a simulator client in the utility computing environment of FIG. 1 according to various embodiments of the present disclosure.

FIG. 4 is a drawing of an example of a user interface rendered by a simulator client in the utility computing environment of FIG. 1 according to various embodiments of the present disclosure.

FIG. 5 is a drawing of an example of a user interface rendered by a simulator client in the utility computing environment of FIG. 1 according to various embodiments of the present disclosure.

FIGS. 6-7 are flowcharts illustrating one example of functionality implemented as portions of the metering simulation service executed in a computing device in the utility computing environment of FIG. 1 according to various embodiments of the present disclosure.

FIG. 8 is a schematic block diagram that provides one example illustration of a simulation system employed in the utility computing environment of FIG. 1 according to various embodiments of the present disclosure.

### DETAILED DESCRIPTION

Embodiments of the present disclosure can facilitate simulation of an advanced metering infrastructure (AMI) deployment. As noted above, an AMI deployment can include millions of metering devices spread across a geographically disparate area. Additionally, AMI utility metering devices in a deployment are typically in service to meter electricity usage of customers and perform other functions as can be appreciated. Accordingly, simulation of various scenarios in order to test the robustness and readiness of back-end AMI systems, such as a message history database, workforce management system, and other systems, cannot easily be accomplished in an AMI deployment that is in service. Accordingly, embodiments of the present disclosure can facilitate the testing of various operational conditions by simulating the behavior of utility metering devices in an AMI deployment so that operators of an AMI system can determine whether the back-end systems that support an AMI deployment are functioning properly. In the following discussion, a general description of the system and its components is provided, followed by a discussion of the operation of the same.

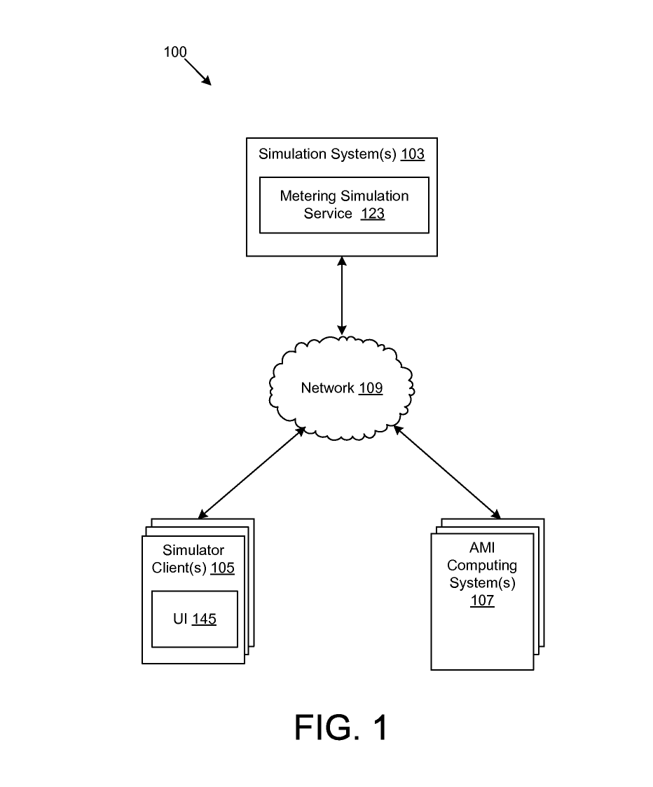

With reference to FIG. 1, shown is a utility computing environment 100 according to various embodiments. The utility computing environment 100 includes a simulation system 103, one or more simulator clients 105, and one or more AMI computing systems 107 in communication over a network 109. The network 109 includes, for example, the Internet, intranets, extranets, wide area networks (WANs), local area networks (LANs), wired networks, wireless networks, or other suitable networks, etc., or any combination of two or more such networks.

The simulation system 103, simulator client 105, and/or AMI computing system 107 may comprise, for example, a computing device that includes a server computer or any other system providing computing capability. Alternatively, a plurality of computing devices may be employed that are arranged, for example, in one or more server banks or computer banks or other arrangements. For example, a plurality of computing devices together may comprise a cloud computing resource, a grid computing resource, and/or any other distributed computing arrangement. Such computing devices may be located in a single installation or may be distributed among many different geographical locations. For purposes of convenience, the computing device is referred to herein in the singular. Even though the computing device is referred to in the singular, it is understood that a plurality of computing devices may be employed in the various arrangements as described above.

The components executed on the simulation system 103 include, for example, a metering simulation service 123, and other applications, services, processes, systems, engines, or functionality not discussed in detail herein. The metering simulation service 123 is executed to provide simulation of a deployment of utility metering devices. Accordingly, the metering simulation service 123 stores or executes a plurality of meter simulators which are tasked with maintaining various information about metering devices as well as logic that causes the meter simulator to respond to data inputs and outputs as if it were a real-world utility metering device in an AMI deployment. In one embodiment, the metering simulation service 123 can simulate the functions of an AMI head-end. An AMI head-end is often provided by the manufacturer or vendor of AMI utility metering devices. Utility computing systems can interact with the AMI head-end to communicate with and/or receive data from utility metering devices in an AMI deployment for the purposes of metering usage, determining the status of a utility deployment, and other purposes as can be appreciated. The functionality of the metering simulation service 123 is discussed in more detail below.

The simulator client 105 is representative of a plurality of client devices that may be coupled to the network 109. The simulator client 105 may comprise, for example, a processor-based system such as a computer system. Such a computer system may be embodied in the form of a desktop computer, a laptop computer, a personal digital assistant, a cellular telephone, set-top box, music players, web pads, tablet computer systems, game consoles, or other devices with like capability.

The simulator client 105 may be configured to execute various applications such as a browser and/or other applications. The browser may be executed in a computing device, for example, to access and render network pages, such as web pages, or other network content served up by the simulation system 103 and/or other servers. The simulator client 105 may be configured to execute applications beyond a browser such as, for example, email applications, instant message applications, and/or other applications. The simulator client 105 can also execute a special purpose application configured to communicate with the metering simulation service 123 to provide the functionality described herein. The simulator client 105, no matter its specific implementation, can render a simulator user interface 145 through which a user can initiate and/or modify simulations as well as view the status of a simulation.

The AMI computing system 107 is representative of one or more computing devices that are generally found in a utility computing environment to facilitate metering, monitoring, and other functionality with regard to an AMI deployment. An AMI computing system 107 can include, as one example, a workforce management system that can facilitate the dispatching and allocation of personnel and/or equipment for the purposes of addressing maintenance and/or outage issues with utility infrastructure. An AMI computing system 107 can also include, as one example, a message history database that is responsible for logging communications from utility metering devices, an AMI head-end, and other systems in a utility computing environment as can be appreciated. An AMI computing system 107 can additionally include, as another example, a customer information system from which communications from customers regarding outages and other potential issues can be received from utility customers.

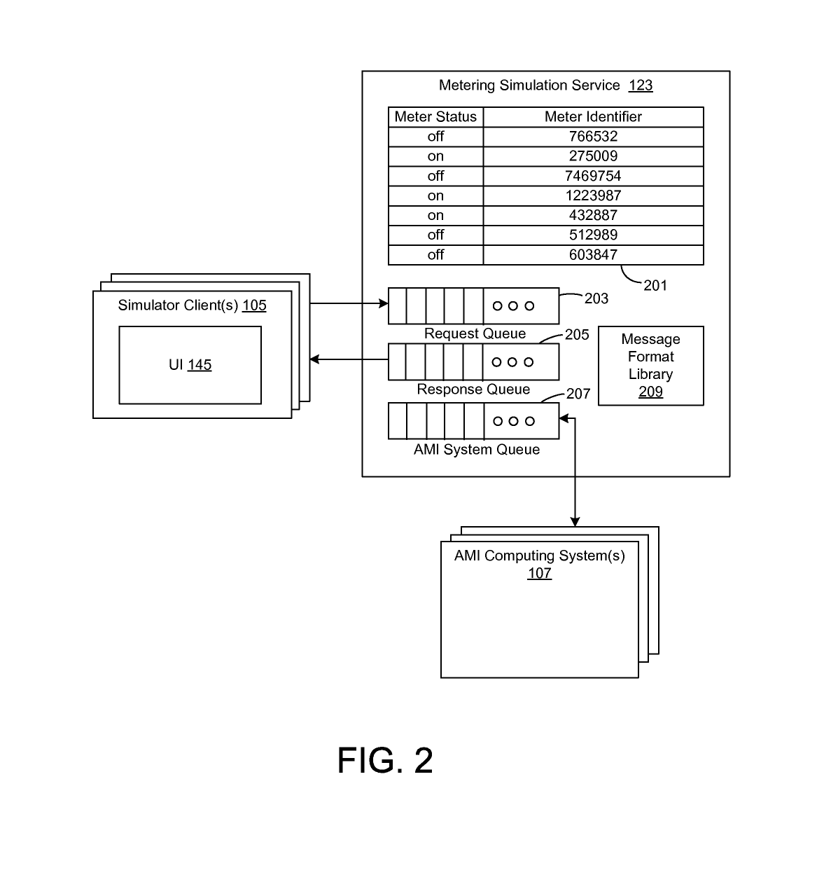

Reference is now made to FIG. 2, which illustrates one example of the components executed and/or stored within a metering simulation service 123 in order to effectuate embodiments of this disclosure. In a utility computing environment, the various AMI computing systems 107 can be in communication with an AMI head-end, which provides the ability for the AMI computing systems 107 to communicate with the various utility metering devices in an AMI deployment. In the depicted embodiment, the AMI computing systems 107 in a utility computing environment can be configured to communicate with the metering simulation service 123 instead of the AMI head-end in order to run a simulation.

Accordingly, the metering simulation service 123 can execute various meter simulators 201, which represent various utility metering devices that can be simulated by the metering simulation service 123. The meter simulators 201 can be associated with a meter identifier as well as a meter state or status. The meter simulators 201 can, in one example, be a state machine that maintains the state of utility metering devices, and the state can change based upon external inputs applied by a user via a simulator client 105. In one embodiment, a user, via a user interface 145 on a simulator client 105, can transmit a list of meter identifiers that represent actual utility metering devices in an AMI deployment, and the metering simulation service 123 can initiate a meter simulator 201 corresponding to each of the meter identifiers. In the depicted embodiment, the meter identifier can be any identifier with which a meter is associated in a utility computing environment. A meter state can include an on status, an off status, an indeterminate status, a brownout status, a high temperature status, a low temperature status and/or other states that can associated with a utility metering device in an AMI deployment. In other embodiments, the meter state may be one of a plurality of possible states, such as a tamper state, a restored state, an outage state, or other states that may correspond to events generated by a meter simulator 201. The meter metering simulation service 123 can also include a request queue 203, which queues requests from a simulator client 105 to communicate with the metering simulation service 123 and/or its meter simulators 201. In one example, the request queue 203 can include requests from a simulator client 105 to alter the state of a meter state.

In another example, the request queue 203 can include requests from a simulator client for one or more meter simulators 201 to generate a meter event. A meter event can include, for example, a tamper event, an outage event, a restore event, or any other type of event that can be generated by a utility metering device. As one example, a user, via a user interface 145, can request that one or more meter simulators 201 generate an event and/or change a meter state. Accordingly, a meter simulator 201 can respond to the simulator client 105, with responses for one or more simulator clients 105 being queued in a response queue 205 by the respective meter simulator 201 attempting to communicate with a simulator client 105.

The metering simulation service 123 also includes an AMI system queue 207, which can queue data received from and/or transmitted to an AMI computing system 107. As noted above, the various AMI computing systems 107 in a utility computing environment can be configured to communicate with the metering simulation service 123 instead of an AMI head-end, and the metering simulation service 123 can simulate the interactions with the AMI computing systems 107 as if they are in communication with the head-end. Accordingly, the metering simulation service 123 can respond to requests received from AMI computing systems 107 in the same way as an AMI head-end. Therefore, messages received from an AMI computing system 107 can be queued in the AMI system queue 207, and the metering simulation service 123 can extract the message from the AMI system queue 207, process its contents, and submit a response to the AMI computing system 107.

As one example, the metering simulation service 123 can receive a request from a simulator client 105 to generate an outage event in one or more meter simulators 201. Accordingly, the metering simulation service 123 can generate a request for an AMI computing system 107 such as a workforce management application or an outage management system to generate a maintenance work order as an AMI head-end would. Therefore, such a request can be queued in the AMI system queue 207. As another example, an AMI computing system 107 can submit a request to ping a particular metering device corresponding to a meter simulator 201. Accordingly, the metering simulation service 123 can identify the meter state associated with the corresponding meter simulator 201, and generate an appropriate response to the requesting AMI computing system 107, which can be queued in the AMI system queue 207 and/or a separate outbound queue. For example, if the meter state is an off status, then the metering simulation service 123 can respond to the ping request with a negative acknowledgement to simulate a response from a metering device that is off or unreachable. Alternatively, if the meter state is an on status, then the metering simulation service 123 can respond to the ping request with a positive acknowledgement. Other variations should be appreciated by a person of ordinary skill in the art.

Because AMI head-ends can be implemented by various manufacturers and/or with varying communications protocols and message formats, the metering simulation service 123 can also include a message format library 209 that facilitates communication with AMI computing systems 107 in the same message format in which AMI head-end would communicate. Accordingly, in one embodiment, the metering simulation service 123 can receive a ping request from an AMI computing system 107 and respond with a response message formatted as specified by the message format library 209 for a particular AMI head-end type. In this way, the metering simulation service 123 can simulate various versions of AMI deployments that may be supplied by various manufacturers.

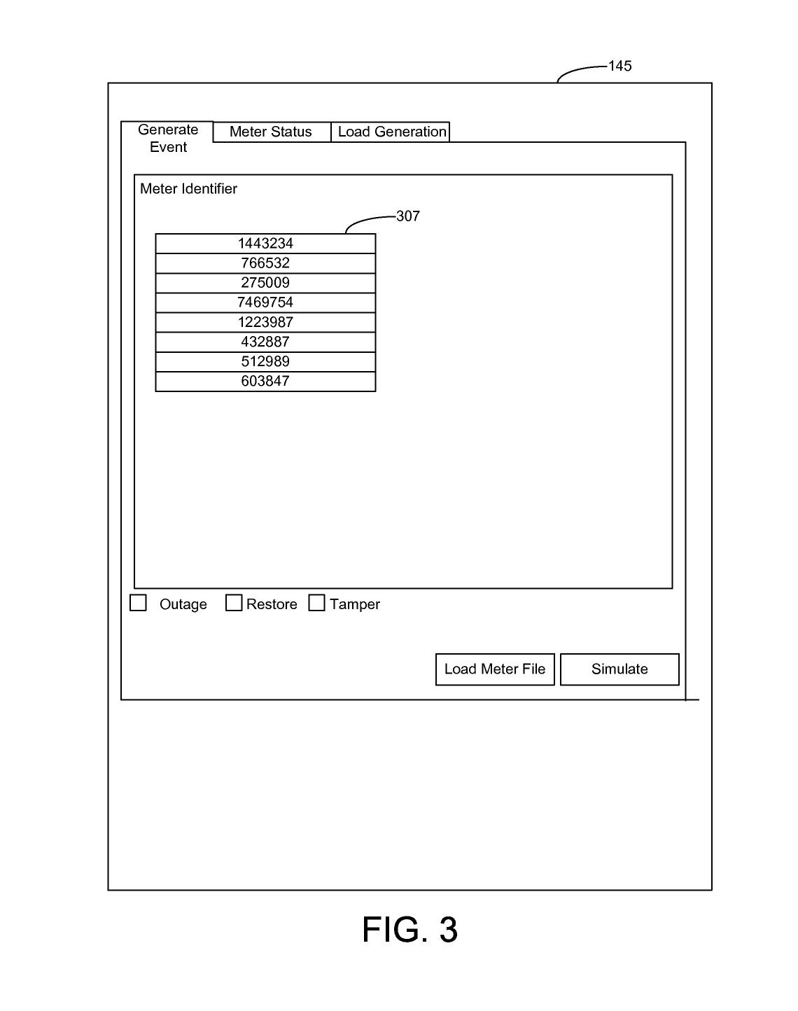

To further illustrate the capabilities of the metering simulation service 123 according to various embodiments of the disclosure, reference is now made to FIGS. 3-5, which illustrates an example of a user interface 145 in a simulator client 105. The depicted user interface 145 illustrates one non-limiting example of a user interface in a simulator client 105 to illustrate the configuration of a metering simulation service 123. In the depicted example of FIG. 3, when in the “generate events” view, a user can submit a list of meter identifiers 307 for which the user desires to initiate a meter simulator 201 in the metering simulation service 123. A list of meter identifiers can be submitted via a simulator client 105 by submitting a file containing a list of meter identifiers. In some embodiments, however, meters for which a user desires to initiate a meter simulator 201 can be selected from a list of meter identifiers corresponding to utility metering devices retrieved from a customer information system or other AMI computing system 107 that is accessible by the simulator client 105 and/or metering simulation service 123.

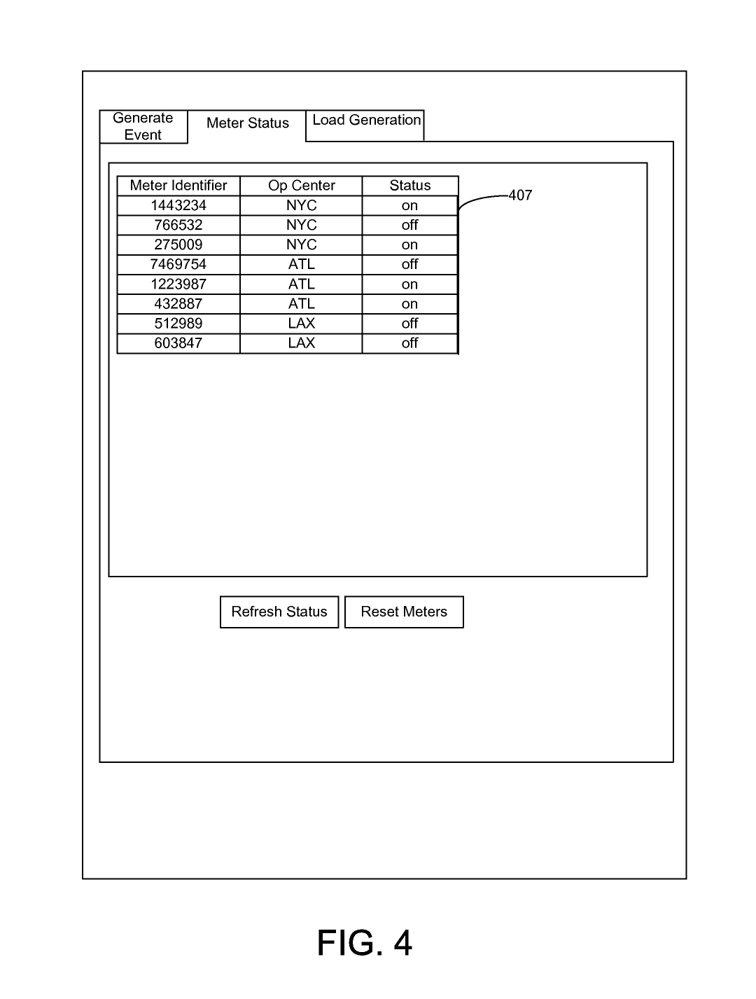

In the depicted example, the user can also select one or more of the meter identifiers 307 and designate one or more events that the user desires to generate that correspond to the meter simulator 201. In this way, a user can initiate meter simulators 201 in a metering simulation service 123 as well as generate events within those meter simulators 201 that correspond to a particular testing scenario the user is attempting to carry out. Moving to the “meter status” view, as illustrated in FIG. 4, a user can also, via the user interface 145, reset the status of the meter simulators 201 executed in the metering simulation service 123.

In the user interface 145 view shown in FIG. 4, the user can view the status of the meter simulators 201 that a metering simulation service 123 is currently executing. In the depicted list of meter identifiers 407 that correspond to meter simulators 201 in the metering simulation service 123, the meter simulators are shown with a meter identifier corresponding to the meter simulator 201 as well as a meter state and an operations center associated with an the utility metering device with which the identifier is associated. Accordingly, the simulator client 105 can request the status of meter simulators 201 from the metering simulation service 123.

The non-limiting example shown in FIG. 4 illustrates how the metering simulation service 123 can also retrieve various information about a particular metering device corresponding to the executing meter simulators 201 and display this information in the user interface 145. In the depicted example, the metering simulation service 123 can retrieve an operations center with which the meter is associated from an AMI computing system 107. The simulation service can also retrieve other information associated with a metering device for which a meter simulator 201 is executed, including, but not limited to, a utility operating company, geographical coordinates, other meter identifiers, and other information as can be appreciated.

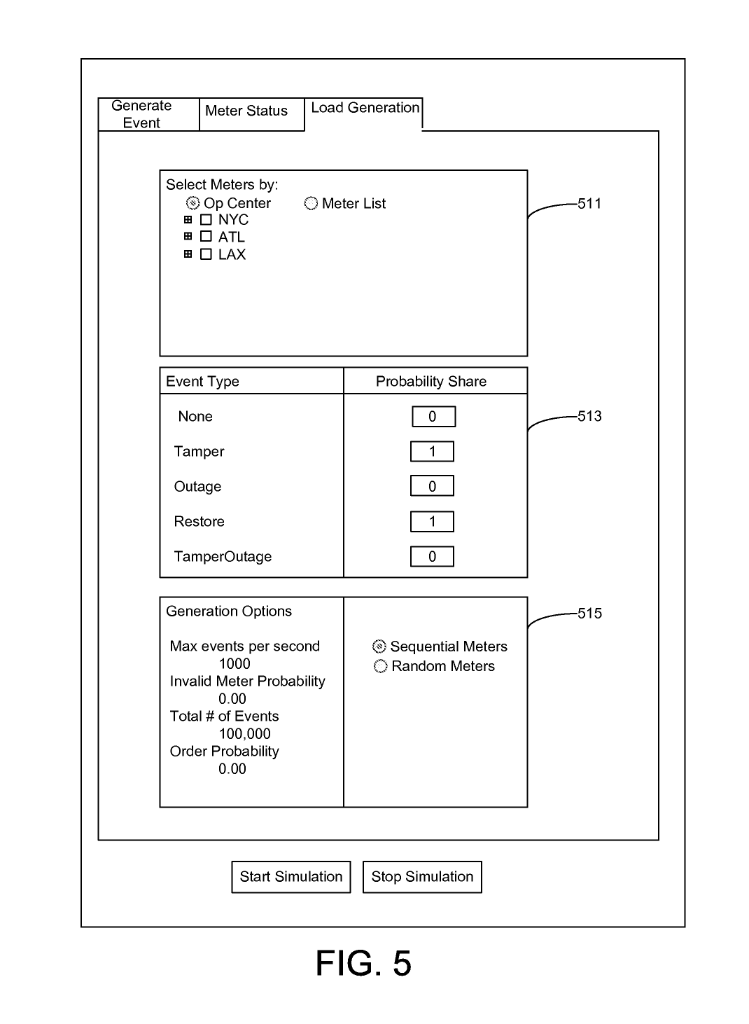

Reference is now made to FIG. 5, which illustrates additional ways in which the metering simulation service 123 and meter simulators 201 can be configured by a user via a simulator client 105. Moving to the “load generation” view illustrated in FIG. 5, a user can configure the metering simulation service 123 to effectuate simulation of various scenarios involving metering devices for which meter simulators 201 are executed. In the depicted meter selection user interface element 511, a user can select meter simulators to configure based upon an operations center with which they are associated.

In this way, the metering simulation service 123 can be employed to simulate various operational scenarios based on geography. In the depicted example, a user on a simulator client 105 can select all meter simulators 201 associated with a particular operations center, or the user can expand an operations center and select meter simulators 201 according to more narrow criteria, such as, region, neighborhood, meter identifier, or other criteria as can be appreciated. In some embodiments, the user interface 145 can also include mapping capability so that a simulation can be viewed and/or configured in a graphical map user interface. As the geographical coordinates of a metering device associated with a meter simulator 201 can be determined, the meter simulators 201 executed in the metering simulation service 123 can be shown on a map so that the user can configure simulations accordingly.

The depicted user interface 145 also shows an event probability configuration element 513, which allows a user to weight the occurrence of one or more events in a simulation effectuated by the meter simulators 201 in the metering simulation service 123. As shown in the non-limiting example in FIG. 5, a user can designate a probability share associated with the various event types that a metering device can generate, and the metering simulation service 123 and/or meter simulators 201 can randomly generate events according to the selected probability share of the event types. In the depicted example, the selected meter simulators 201 are configured by the simulator client 105 with equal probability shares for tamper events and restore events, but with a zero probability share for other event types. Accordingly, upon commencement of a simulation, the meter simulators 201 selected in the meter selection user interface element 511 will generate tamper events and restore events at approximately equal levels during the course of the simulation.

The generation options element 515 provides a user on a simulator client 105 with additional configuration capabilities with which the metering simulation service 123 can be adjusted. As shown in the depicted non-limiting example, the metering simulation service 123 can be configured to generate a maximum number of events per a unit of time as well as a total number of events. Additionally, the metering simulation service 123 can be configured to generate events corresponding to invalid meter identifiers to test the ability of AMI computing systems 107 to handle potentially invalid data. Invalid meter identifiers can also be generated to test the ability of AMI computing systems 107 to handle missing data, such as an out-of-date mapping between vendor meter identifiers and internal meter identifiers. Accordingly, the generation options element 515 can be configured to receive an invalid meter probability with which the metering simulation service 123 can be configured. Additionally, the metering simulation service 123 can be configured to generate events sequentially by meter identifier or randomly.

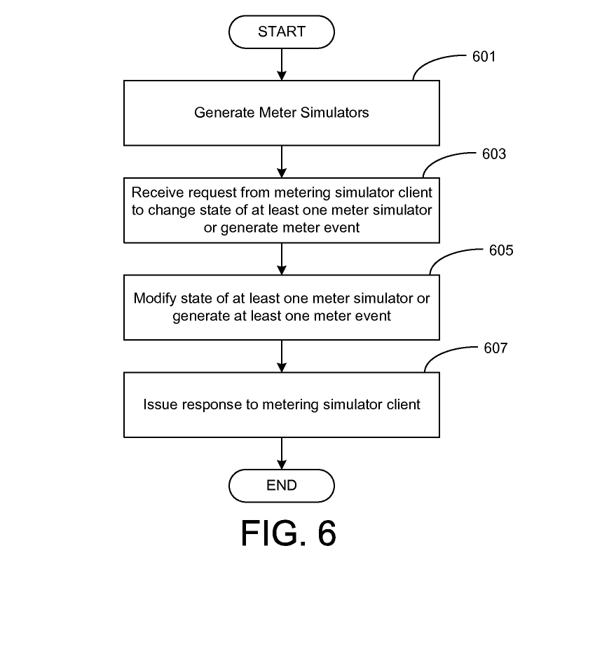

Referring next to FIG. 6, shown is a flowchart that provides one example of the operation of a portion of the metering simulation service 123 according to various embodiments. It is understood that the flowchart of FIG. 6 provides merely an example of the many different types of functional arrangements that may be employed to implement the operation of the portion of the metering simulation service 123 as described herein. As an alternative, the flowchart of FIG. 6 may be viewed as depicting an example of steps of a method implemented in the simulation system 103 (FIG. 1) according to one or more embodiments.

Beginning with box 601, the metering simulation service 123 generates one or more meter simulators. As described above, a user via a simulator client 105 can specify one or more meter identifiers that correspond to utility metering devices in an AMI deployment for which a simulation is desired in the metering simulation service 123. In box 603, a request from the simulator client 105 to modify a state of at least one meter simulator or cause a meter simulator 201 to generate an event is received by the metering simulation service 123. In response, in box 605, the metering simulation service 123 can modify the state of at least one meter simulator and/or cause an event to be generated by at least one meter simulator. Finally, in box 607, a response can be issued to the simulator client 105.

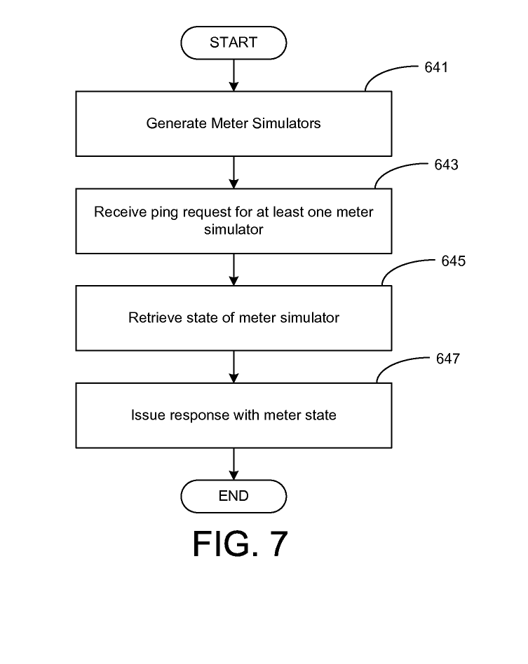

Referring next to FIG. 7, shown is a flowchart that provides one example of the operation of a portion of the metering simulation service 123 according to various embodiments. It is understood that the flowchart of FIG. 7 provides merely an example of the many different types of functional arrangements that may be employed to implement the operation of the portion of the metering simulation service 123 as described herein. As an alternative, the flowchart of FIG. 7 may be viewed as depicting an example of steps of a method implemented in the simulation system 103 (FIG. 1) according to one or more embodiments.

FIG. 7 illustrates one way in which the metering simulation service 123 can respond to a ping request that can be received from a metering client, an AMI computing system or other system. Beginning with box 641, the metering simulation service 123 generates one or more meter simulators. As described above, a user via a simulator client 105 can specify one or more meter identifiers that correspond to utility metering devices in an AMI deployment for which a simulation is desired in the metering simulation service 123. In box 643, the metering simulation service 123 can receive a ping request for at least one meter simulator. Such a ping request can be received from a metering client, an AMI computing system, or another computing system. The ping request can identify a metering device and/or a meter simulator by a meter identifier. Accordingly, in box 645, the metering simulation service 123 can retrieve a meter state or status associated with the meter simulator. In box 647, the metering simulation service 123 can issue a response that includes the meter state as well as other information.

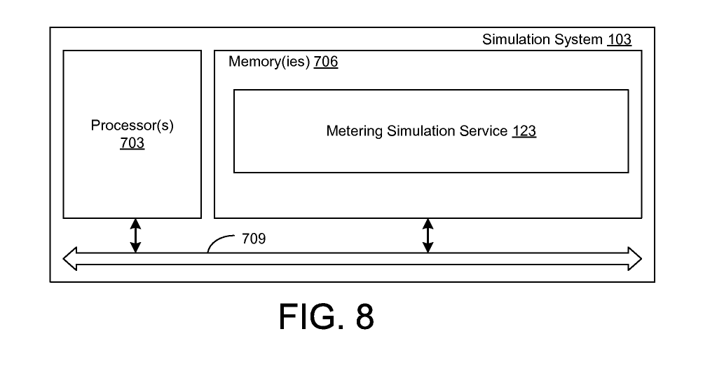

With reference to FIG. 8, shown is a schematic block diagram of the simulation system 103 according to an embodiment of the present disclosure. The simulation system 103 includes at least one processor circuit, for example, having a processor 703 and a memory 706, both of which are coupled to a local interface 709. To this end, the simulation system 103 may comprise, for example, at least one server computer or like device. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 are the metering simulation service 123, and potentially other applications. In addition, an operating system may be stored in the memory 706 and executable by the processor 703.

It is understood that there may be other applications that are stored in the memory 706 and are executable by the processors 703 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and the memory 706 may represent multiple memories 706 that operate in parallel processing circuits, respectively. In such a case, the local interface 709 may be an appropriate network 109 (FIG. 1) that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the metering simulation service 123 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 6-7 show the functionality and operation of an implementation of portions of the metering simulation service 123. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flowcharts of FIGS. 6-7 show a specific order of execution, it is understood that the order of execution may differ from that which is depicted. For example, the order of execution of two or more blocks may be scrambled relative to the order shown. Also, two or more blocks shown in succession in FIGS. 6-7 may be executed concurrently or with partial concurrence. Further, in some embodiments, one or more of the blocks shown in FIGS. 6-7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the metering simulation service 123, that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
at least one computing device; and
a metering simulation service executable in the at least one computing device, the metering simulation service comprising:
logic that generates a plurality of meter simulators, the meter simulators comprising a meter identifier and a meter state;
logic that receives at least one message from a metering client, the at least one message corresponding a request to modify the meter state associated with at least a subset of the meter simulators;
logic that modifies the meter state associated with the at least a subset of the meter simulators; and
logic that issues a response to the metering client on behalf of the at least a subset of the meter simulators.

2. The system of claim 1, wherein each of the meter simulators further comprises a state machine including a plurality of states associated with the meter simulator.

3. The system of claim 2, wherein the meter state is one of: an on state an off state, an indeterminate state, a brownout state, a high temperature state, and a low temperature state.

4. The system of claim 1, wherein each of the meter simulators is configured to generate a plurality of events, the events comprising at least one of an outage event, a restore event, and a tamper event.

5. The system of claim 1, wherein the metering simulation service further comprises a metering client request queue configured to queue incoming requests from the metering client.

6. The system of claim 1, wherein the metering simulation service further comprises a metering client response queue configured to queue outgoing responses to the metering client on behalf of the meter simulators.

7. The system of claim 1, wherein the metering simulator client is configured to associate the meter identifier associated with the meter simulators with at least one of an operating company and a geographic location.

8. The system of claim 1, wherein the metering simulation service further comprises an AMI queue configured to queue messages from the metering simulators to at least one utility system.

9. The system of claim 8, wherein the at least one utility system is further configured to communicate with the metering simulation service; and the metering simulation service further comprises:
logic that receives a message from the at least one utility system;
logic that extracts a message meter identifier from the message;
logic that identifies a meter simulator having a meter identifier corresponding to the message meter identifier;
logic that identifies a meter state associated with the meter identifier;
logic that generates a response to the message based at least upon the identified meter state; and
logic that queues the response in the AMI queue.

10. The system of claim 9, wherein the message is a ping request.

11. The system of claim 1, wherein the meter simulators are further configured to generate a meter event corresponding to a change in the meter state.

12. The system of claim 11, wherein the meter event is at least one of a tamper event, a power failure vent and a power restore event.

13. A method, comprising the steps of:
generating, in at least one computing device a plurality of meter simulators, the meter simulators comprising a meter identifier and a meter state;
receiving, in at least one computing device, at least one message from a metering client, the at least one message corresponding to a request to cause at least one of the meter simulators to generate an event;
generating, in at least one computing device, the event in the at least one of the meter simulators; and
issuing, in at least one computing device, a response to the metering client on behalf of the at least of the meter simulators.

14. The method of claim 13, wherein each of the meter simulators further comprises a state machine, wherein the meter state is one of: an on state and an off state.

15. The method of claim 13, wherein the events comprises at least one of an outage event, a restore event, and a tamper event.

16. The method of claim 13, further comprising the step of queuing, in at least one computing device, incoming requests to generate at least one event in a metering simulator from the metering client.

17. The method of claim 13, further comprising the step of queuing, in at least one computing device, outgoing responses to the metering client on behalf of the meter simulators.

18. The method of claim 13, wherein the metering simulator client is configured to associate the meter identifier associated with the meter simulators with at least one of an operating company and a geographic location.

19. The method of claim 13, further comprising the step of queuing messages from the metering simulators to at least one utility computing system.

20. The method of claim 19, wherein the at least one utility computing system is further configured to communicate with the at least one computing device; and the method further comprises the steps of:
receiving a message from the at least one utility computing system;
extracting a meter identifier from the message;
identifying a meter simulator having a meter identifier corresponding to the message meter identifier;
identifying a meter state associated with the meter simulator;
generating a response to the message; and
queuing the response in the AMI queue.

21. The method of claim 20, wherein the message is a ping request.
